(19) United States
(12) Patent Application Publication
(10) Pub. No.: US 2020/0080237 A1
(43) Pub. Date: Mar. 12, 2020

(54) TOUGH, HIGH IMPACT RESISTANT 3D PRINTED OBJECTS FROM STRUCTURED FILAMENTS

(71) Applicants: Bryan David Vogt, Akron, OH (US); Mukerrem Cakmak, Lafayette, IN (US); Fang Peng, Greensboro, NC (US)

(72) Inventors: Bryan David Vogt, Akron, OH (US); Mukerrem Cakmak, Lafayette, IN (US); Fang Peng, Greensboro, NC (US)

(73) Assignee: THE UNIVERSITY OF AKRON, Akron, OH (US)

(21) Appl. No.: 16/567,014

(22) Filed: Sep. 11, 2019

Related U.S. Application Data
(60) Provisional application No. 62/729,757, filed on Sep. 11, 2018.

(51) Int. Cl. D01F 8/04; B33Y 70/00

(52) U.S. Cl. CPC D01F 8/04; B33Y 80/00; B33Y 70/00

(57) ABSTRACT

In various embodiments the invention is directed to a structured filament for use in fused filament fabrication comprising an inner core comprising an first polymer or polymer blend; and an outer shell surrounding said inner core comprising a second polymer or polymer blend having ionic or crystalline functionality; wherein said first polymer or polymer blend has a higher solidification temperature than said second polymer or polymer blend. The ionic or crystalline functionality of the outer shell material strengthen the interface between the printed layers. This structured filament leads to printed 3D structures having improved dimensional fidelity and impact resistance in comparison to the individual components. The impact resistance of structures printed from these is greatly increased as energy is dissipated by delamination of the shell from the core near the crack tip, while the core remains intact to provide stability to the part after impact.

### CROSS REFERENCE TO RELATED APPLICATIONS

This application claims the benefit of U.S. provisional patent application Ser. No. 62/729,757 entitled “Tough, High Impact Resistant 3D Printed Objects from Structured Filaments,” filed Sep. 11, 2018, and incorporated herein by reference in its entirety.

### FIELD OF THE INVENTION

One or more embodiments of the present invention relates to additive manufacturing or three dimensional printing with extrusion type printers. In certain embodiments, the present invention relates to multicomponent structured filaments for use in fused filament fabrication.

### BACKGROUND OF THE INVENTION

3D printing has been a key enabler of rapid prototyping for developing new designs and concepts, but the production of functional objects by 3D printing has been limited by the availability of high performance feedstocks and poor understanding of topology optimization. Recently, there has been a significant push towards bridging the gap to enable 3D printing to be extended to final products. Most technologies to print plastic parts build in a layer-by-layer manner, which leads to weak points at the interfaces of each layer. These internal interfaces, similar to weld lines, act to limit the performance of 3D printed parts. Despite this challenge of the interfacial strength during the part build, significant advances have been made in the past decade, especially with respect to the potential for personalized medical devices made to fit the patient. These can range from models to aid in complex surgeries to scaffolds for bone and soft tissue engineering. Beyond the biomedical potential, 3D printing offers advantages of lightweighting by printing cellular solids that can outperform standard materials and the ability to generate complex, multicomponent objects with advanced functionality such as soft, autonomous robots. For plastic materials, there has been a push to enhance the functionality of the material being printed. This has included increased maximum operating temperature, improved elasticity, increased stiffness, and responsiveness of the printed parts. In particular, responsive materials enable 4D printing, which represents a new paradigm for adaptive structures. Similarly, functionality enabled by 3D printing has been exploited in the production of lightweight metamaterials that exhibit unique properties including negative coefficient of thermal expansion. However, the printing method tends to remain a limitation with the mechanical properties of 3D printed parts being inferior to traditional manufacturing methods.

One common technique for 3D printing of polymers is fused filament fabrication (FFF) where a thermoplastic filament is rapidly melted through a rastering hotend and deposited on the build stage to build the part in a layer-by-layer fashion. This simple technique relies on the deposited molten polymer melting the underlying layer to generate a viable interface, while the flow of the molten polymer must be limited to prevent deformation of the part. The orthogonal nature of these requirements leads to trade-offs between shape fidelity and the mechanical properties of the part. Much of the work on FFF has focused on trying to optimize the processing conditions to generate the best mechanical properties in the 3D printed part, but these are inferior, generally by almost an order of magnitude, to the comparable injection molded part. Most efforts to date to improve the properties of FFF parts has focused on using new polymers and engineering design of the printers, but these approaches fail to address the intrinsic underlying flaw in FFF of the poor interfaces between layers. In particular, these 3D printed parts suffer from poor impact performance, which limits their use in demanding applications.

A wide variety of thermoplastic filaments have been formulated that include amorphous polymers composites, semicrystalline polymers and recently ionomers. These filaments are generally fabricated to be homogeneous. The layer-by-layer approach used to print via FFF leads to weak points in the sample from the defects at the interfaces that develop during priming. This intrinsically tends to lead to poor mechanical properties of parts fabricated by FFF. In addition, a majority of the volume of polymers used in products are semicrystalline, but 31) printing of semicrystalline polymers is challenged by the volume change from the amorphous melt as printed to the solid semicrystalline state. This volume change tends to lead to deformation of the object. This is an additional issue with 3D printing of semicrystalline polymers, which also generally suffer from inferior mechanical properties.

Structured filaments can provide some advantages in the printing process, such as those noted in U.S. Pat. Application. No. PCT/US17/29876 and those cited herein. U.S. Published Application No. US 2014/0291886A1 discloses a method for a core reinforced filament. International Published Application WO 2015/077262A1 describes the fabrication of multicomponent filaments where a high glass transition amorphous polymer surrounds a low glass transition amorphous polymer. International Published Application WO 2018/199959 (U.S. Patent Application PCT/US17/29876) describes the selection of amorphous polymer-pairs for 2 component filaments for printing parts using FFF with slightly enhanced mechanical properties and larger print processing windows, but uses filaments that contain 2 amorphous polymers with the lower glass transition polymer at the surface of the filaments. None of these structured filaments, however, have been shown to form 3D structures having high impact resistance and good printing accuracy.

What is needed in the art is a structured polymer filament for use in FFF that provides printed 3D structures having improved dimensional printing accuracy, increased impact resistance, and do not warp or deform upon cooling.

### SUMMARY OF THE INVENTION

In various embodiments, the present invention directly addresses the weak interfaces through a materials design approach using core-shell structured filaments. These filaments overcome the general trade-off between shape fidelity and the mechanical properties through a high glass transition temperature (T_{g}) core that acts as a “stiff skeleton” to reinforce the printed shape and low T_{g} shell that enables improved interdiffusion of polymers between adjacent printed layers. The shell polymer contains crystallinity and/or ionic functionality to further improve these interfaces as this functionality provides routes to improve the bridging across the interface. These attributes enable 3D printing of polymeric parts with unprecedented impact resistance (>800 J/m) with the low adhesion between the core and the shell layer providing an additional mechanism for energy dissipation through local delamination on impact. This materials design approach using structured filaments opens a new paradigm for the 3D printing of functional polymeric objects.

In a first aspect, the present invention is directed to a structured filament for use in fused filament fabrication comprising an inner core comprising an first polymer or polymer blend; and an outer shell surrounding the inner core comprising a second polymer or polymer blend; wherein the first polymer or polymer blend has a higher solidification temperature than the second polymer or polymer blend. In one or more of these embodiments, the polymer or polymer blend forming the inner core is amorphous. In one or more embodiments, the structured filament of the present invention includes any one or more of the above referenced embodiments of the first aspect of the present invention wherein the first polymer or polymer blend comprises a polycarbonate, polyphenol-A based polycarbonate, MAKROLON™ 3208 (Covestro, Inc., Pittsburgh, Pa.), polypropylene, nylon, poly(p-phenylene oxide) (PPO), a polycarbonate/acrylonitrile butadiene styrene (ABS) blend, BAYBLEND™ T45 PG (Covestro, Inc., Pittsburgh, Pa.) or a combination thereof.

In one or more embodiments, the structured filament of the present invention includes any one or more of the above referenced embodiments of the first aspect of the present invention wherein the first polymer or polymer blend has a glass transition temperature (T_{g}) of from about 90° C. to about 300° C. In one or more embodiments, the structured filament of the present invention includes any one or more of the above referenced embodiments of the first aspect of the present invention wherein the second polymer or polymer blend has a T_{g} of from about 40° C. to about 150° C. In one or more embodiments, the structured filament of the present invention includes any one or more of the above referenced embodiments of the first aspect of the present invention wherein the second polymer or polymer blend has a crystallization temperature (T_{c}) of from about 40° C. to about 150° C.

In one or more embodiments, the structured filament of the present invention includes any one or more of the above referenced embodiments of the first aspect of the present invention wherein the second polymer or polymer blend comprises at least one of crystalline segments and ionizable segments. In one or more embodiments, the structured filament of the present invention includes any one or more of the above referenced embodiments of the first aspect of the present invention wherein the second polymer or polymer blend comprises from about 0 mol % to about 10 mol % ionizable segments. In one or more embodiments, the structured filament of the present invention includes any one or more of the above referenced embodiments of the first aspect of the present invention wherein the second polymer or polymer blend comprises one or more crystalline segments. In one or more embodiments, the structured filament of the present invention includes any one or more of the above referenced embodiments of the first aspect of the present invention wherein the second polymer or polymer blend is partially crystalline after printing. In one or more embodiments, the structured filament of the present invention includes any one or more of the above referenced embodiments of the first aspect of the present invention wherein the second polymer or polymer blend is selected from an olefin ionomer, zinc neutralized poly(ethylene-co-methacrylic acid), SURLYN™ 9910 (DuPont de Nemours, Inc., Wilmington, Del.), NUCREL™ (Dow, Midland Mich.), ELTEX™ (Ineos, London, UK), PRIMACORE™ (SK Global Chemicals, Seoul, Korea), high density polyethylene, SUNTEC™ B161 (Asahi Kasei, Japan), ADSYL™ 5C37F (LyondellBasell Chemicals Company, Rotterdam, Netherlands), and a combination thereof.

In one or more embodiments, the structured filament of the present invention includes any one or more of the above referenced embodiments of the first aspect of the present invention wherein the energy required to separate the inner core from the outer shell is less than the energy required to propagate a crack through the outer shell. In one or more embodiments, the structured filament of the present invention includes any one or more of the above referenced embodiments of the first aspect of the present invention wherein the first polymer or polymer blend has a solidification temperature that is from about 5° C. to about 260° C. higher than the solidification temperature of the second polymer or polymer blend. In one or more embodiments, the structured filament of the present invention includes any one or more of the above referenced embodiments of the first aspect of the present invention wherein the solidification temperature of the first polymer or polymer is at least 5° C. higher than the solidification temperature of the second polymer or polymer blend.

In one or more embodiments, the structured filament of the present invention includes any one or more of the above referenced embodiments of the first aspect of the present invention wherein the inner core comprises from about 35 vol % to about 75 vol % of the structured filament. In one or more embodiments, the structured filament of the present invention includes any one or more of the above referenced embodiments of the first aspect of the present invention wherein the adhesion force between the inner core and outer shell is less than the weld strength between the outer shells of two adjacent 3D printed structured filaments.

In a second aspect, the present invention is directed to a 3D printed structure formed by fused filament fabrication of the structured filament described above. In one or more of these embodiments, the structured filaments forming the 3D structure are comprised of from about 45% to about 60% of the second polymer or polymer blend, the second polymer or polymer blend forming the outer shell of the structured filaments; the structured filaments are welded together at their outer shells to form the 3D printed structure, the welds between the outer shells of two adjacent structured filaments in the 3D printed structure having a weld strength; the inner core and outer shell of the structured filaments are joined together with an adhesive force; and the adhesive force between the inner core and outer shell is less than a weld strength between the outer shells of two adjacent structured filaments in the 3D printed structure.

In one or more embodiments, the 3D printed structure of the present invention includes any one or more of the above referenced embodiments of the second aspect of the present invention wherein the 3D printed structure resists warping. In one or more embodiments, the 3D printed structure of the present invention includes any one or more of the above referenced embodiments of the second aspect of the present invention having improved dimensional accuracy compared to 3D printed structures formed from comparable filaments made from either one of the first polymer or polymer blend or the second polymer or polymer blend.

In one or more embodiments, the 3D printed structure of the present invention includes any one or more of the above referenced embodiments of the second aspect of the present invention having increased impact resistance compared to 3D printed structures formed from comparable filaments made from either one of the first polymer or polymer blend or the second polymer or polymer blend. In one or more embodiments, the 3D printed structure of the present invention includes any one or more of the above referenced embodiments of the second aspect of the present invention having an impact resistance of 800 J/m or more in an XY (flat) or XZ (edge-on) printing orientation.

### BRIEF DESCRIPTION OF THE DRAWINGS

For a more complete understanding of the features and advantages of the present invention, reference is now made to the detailed description of the invention along with the accompanying figures in which:

FIG. 1 is a schematic diagram of a coextrusion apparatus that may be used to fabricate core-shell filaments according to the present invention;

FIGS. 2A-B are an image showing a design of overhang test specimen (FIG. 2A) and an image showing printed overhang test specimens made using pure Surlyn, a core-shell (Surlyn@ 45% PC) structured filament, and pure PC filaments (FIG. 2B), wherein the maximum overhang angle for PC is 35°, for PC@45% Surlyn is 25° and for Surlyn is 60° (The extrusion temperature of the hot-end was set to 280° C., nozzle speed is 20 mm/min, and the temperature of the print-bed is set to 60° C.);

FIGS. 3A-B are an image comparing the bending of 3D printed parts using pure PC, pure Surlyn, and core-shell (PC@ 45% Surlyn) structured filaments according to one or more embodiments of the present invention (FIG. 3A) and an image comparing the printed parts and the original 3D model (FIG. 3B);

FIG. 4 is a schematic illustrating the 3 different printing orientations examined: XY (flat), XZ (edge-on), and YZ (end-on);

FIGS. 5A-C are graphs showing the impact resistance of 3D printed PC, PC@Surlyn, and Surlyn as determined from the Notched Izod test when the test specimen is printed in the XY (flat) (FIG. 5A); XZ (edge-on) (FIG. 5B); and YZ (end-on) (FIG. 5C) orientation, wherein the specimen is notched after printing to ensure a pre-crack is formed;

FIG. 6A-B is an X-ray OCT image of notched area after impact test for PC@45% Surlyn printed in XY orientation with a SEM micrograph callout that illustrates the buckling of the PC fiber at the crack front (area in black dashed box with a second callout) (FIG. 6A); and an X-ray OCT image of the cross-section of the specimen at the center of the notch illustrates the remaining PC fibers at the crack front, while the Surlyn has delaminated (FIG. 6B);

FIGS. 7A-D are graphs showing tensile properties for 3D printed PC, PC@Surlyn, and Surlyn wherein (FIG. 7A) shows the stress-strain curves of 3D printed parts for 3 different compositions of PC@Surlyn core-shell structured filaments with comparison to the pure components from which the elastic modulus (FIG. 7B), yield and ultimate tensile stress (FIG. 7C), and toughness (FIG. 7D) are determined (the ASTM tensile bar in this case is printed with XY orientation);

FIGS. 8A-C are SEM micrographs illustrating the tensile fracture surfaces of 3D printed parts from filaments of PC (FIG. 8A), Surlyn (FIG. 8B), and core-shell with 45% Surlyn (FIG. 8C) showing that fracture surfaces of parts from single component filaments are rather clean, while the PC@Surlyn filament leads to surfaces reminiscent of fiber reinforced composites;

FIG. 9 is an X-ray μCT image of notched area after impact test for PC@45% Surlyn printed in YZ orientation with an SEM micrograph callout illustrating the core-shell debonding at the crack surface (area in black dashed box);

FIGS. 10A-B are a schematic illustrating 3D printing of the core-shell by FFF (FIG. 10A) and an X-ray tomography image of 3D a printed core-shell (PC@45% Surlyn) filament to illustrate the maintenance of the structure in the printed part, wherein the low electron density of Surlyn (bright) relative to PC (dark) provides contrast to distinguish components with X-rays (FIG. 10B);

FIG. 11 is a plot showing the thermograms for PC and Surlyn that were obtained by separating the components from the fabricated filaments of PC@ Surlyn (here, the heat flow of PC is offset by 1 W/g);

FIGS. 12A-B are cross-section images of co-extruded filaments with 45% Surlyn prior to printing (FIG. 12A) and a core-shell filament after free extrusion from the 3D-printer where the circular crosssection can be maintained (FIG. 12B);

FIG. 13 is a plot showing the shear viscosity of PC and Surlyn at 280° C. from a capillary rheometer (Rosand RH7, Malvern);

FIG. 14 is a graphs showing the force required to peel PC from Surlyn for films (10 mm-wide) welded at 280° C. for 10 s, which corresponds to the thermal history from 3D printing of the core-shell filaments;

FIGS. 15A-B are SEM micrographs of the impact fracture surfaces of pure PC (FIG. 15A) and Surlyn (FIG. 15B) that have been 3D printed;

FIGS. 16A-C are X-ray μCT images of the (left) side view and (right) cross section at the notch for 3D printed core-shell specimens with XZ orientation for PC@25% Surlyn (FIG. 16A), PC@45% Surlyn (FIG. 16B), and PC@55% Surlyn (FIG. 16C);

FIG. 17 CT and SEM images of tested 55% core-shell impact sample (XZ orientation) showing core-shell delamination (callouts); and

FIG. 18 is a schematic illustrating the inhibition of crack formation by core reinforcement in various print orientations.

### DETAILED DESCRIPTION OF THE ILLUSTRATIVE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure.

As set forth above, net shape manufacture of customizable objects through 3D printing offers tremendous promise for personalization to improve the fit, performance and comfort associated with devices and tools used in our daily lives. However, the application of 3D printing in structural objects has been limited by their poor mechanical performance that manifests from the layer-by-layer process by which the part is produced. In various embodiments of the present invention, this interfacial weakness is overcome by a structured, core-shell polymer filament where a polymer core solidifies quickly to define the shape, while a polymer shell contains functionality (crystallinity and ionic) that strengthen the interface between the printed layers. This structured filament leads to improved dimensional fidelity and impact resistance in comparison to the individual components. The impact resistance from structured filaments containing 45 vol % shell can exceed 800 J/m as energy is dissipated by delamination of the shell from the core near the crack tip, while the core remains intact to provide stability to the part after impact. This structured filament provides tremendous improvements in the critical properties for manufacture and represents a major leap forward in the impact properties obtainable for 3D printed parts.

The following terms may have meanings ascribed to them below, unless specified otherwise. As used herein, the terms “comprising” “to comprise” and the like do not exclude the presence of further elements or steps in addition to those listed in a claim. Similarly, the terms “a,” “an” or “the” before an element or feature does not exclude the presence of a plurality of these elements or features, unless the context clearly dictates otherwise. Further, the term “means” used many times in a claim does not exclude the possibility that two or more of these means are actuated through a single element or component.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term “about.”

It should be also understood that the ranges provided herein are a shorthand for all of the values within the range and, further, that the individual range values presented herein can be combined to form additional non-disclosed ranges. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

All publications, patent applications, patents, and other references mentioned herein are expressly incorporated by reference in their entirety, which means that they should be read and considered by the reader as part of this text. That the document, reference, patent application, or patent cited in this text is not repeated in this text is merely for reasons of conciseness. In the case of conflict, the present disclosure, including definitions, will control. All technical and scientific terms used herein have the same meaning.

Further, any compositions or methods provided herein can be combined with one or more of any of the other compositions and methods provided herein. The fact that given features, elements or components are cited in different dependent claims does not exclude that at least some of these features, elements or components may be used in combination together.

In a first aspect, the present invention is directed to a structured filament for use 3D printing of structures by fused filament fabrication (FFF). As used herein, the term “structured filament” generally refers to a filament comprising two or more phases distributed in a regular user defined manner. In various embodiments, the structured filaments of the present invention are comprised of two different polymers or polymer blends arranged in a core-shell configuration. The structured filament has an inner polymer core formed from a first polymer or polymer blend and an outer polymer shell formed from a second polymer or polymer blend. As used herein the term “polymer blend” refers to a substantially homogeneous mixture of two polymers or of a polymer and one or more inorganic particles, such as clay, carbon black, graphite, silica, zinc oxide, titanium, glass, glass beads, graphine, carbon nanotubes, or a combination thereof. As will be apparent to those of skill in the art, the polymer blends used to form the structured filament may also in some embodiments contain small amounts (ordinarily less than 5%) of other fillers such as pigments, dyes, plasticizers, surfactants, antioxidants, or combinations thereof.

The polymer or polymer blend forming the core of the structured filament (the “core material” or “inner core material”) is selected to provide stiffness and rigidity to the printed structure. The particular mechanical properties required for the polymer or polymer blend forming the core of the structured filament will depend upon the particular application and the desired properties of the 3D structures to be formed. In some embodiments, polymer or polymer blend forming the core of the structured filament will be amorphous, but this need not be the case. In various embodiments, the core of the structured filament may comprise a polycarbonate, acrylonitrile butadiene styrene (ABS), polypropylene, polyacrylate, poly(methacrylate), poly(methyl methacrylate) (PMMA) polymer or blend thereof that meets the T_{g} criteria set forth below. In some embodiments, the core of the structured filament may comprise a polyphenol-A based polycarbonate, MAKROLON™ 3208 (Covestro, Inc., Pittsburgh, Pa.), polypropylene, nylon, poly(p-phenylene oxide) (PPO), a polycarbonate/acrylonitrile butadiene styrene (ABS) blend, BAYBLEND™ T45 PG (Covestro, Inc., Pittsburgh, Pa.) or a combination or blend thereof.

In one or more embodiments, the polymer or polymer blend forming the core of the structured filament will have a T_{g} of from about 90° C. to about 300° C. In some embodiments, the polymer or polymer blend forming the core of the structured filament will have a T_{g} of from about 95° C. to about 300° C., in other embodiments, from about 100° C. to about 300° C., in other embodiments, from about 125° C. to about 300° C., in other embodiments, from about 150° C. to about 300° C., in other embodiments, from about 175° C. to about 300° C., in other embodiments, from about 200° C. to about 300° C., in other embodiments, from about 90° C. to about 250° C., in other embodiments, from about 90° C. to about 225° C., in other embodiments, from about 90° C. to about 200° C., and in other embodiments, from about 90° C. to about 175° C. Here, as well as elsewhere in the specification and claims, individual range values can be combined to form additional non-disclosed ranges.

As set forth above, the structured filament of the present invention further comprises an outer shell surrounding the inner core comprising a second polymer or polymer blend. As will be apparent to those of skill in the art, during fused filament fabrication (FFF), adjacent outer shells of the filaments being printed fuse or weld together to form the 3D structure being printed. To improve adhesion at the interface between adjacent filaments, the outer polymer shell contains functionality (crystallinity and ionic) that strengthen the interface between the printed layers.

In one or more embodiments, the polymer or polymer blend used to form the outer shell of the structured filament of the present invention (the outer shell material) will comprise one or more of crystalline segments and/or ionizable segments as this functionality provides routes to improve the bridging across the interfaces between filaments and printing layers. As used herein, the term “crystalline segments” refers to a span of monomers in a single polymer chain that are capable of forming a crystal when cooled below their crystallization temperature (T_{c}). As used herein, the terms “semicrystalline” and “partially crystalline” when applied to a polymer or polymer blend, are used interchangeably to refer to a polymer or polymer blend having from about 10 mol % to about 99 mol % crystalline segments. The term “ionizable segments” is used herein to refer to segments of the polymer chain having one or more ionic functional groups, including without limitation, sulfate, carbonate, or phosphate groups, paired with a counter ion, such as a transitional metal ion, alkali ion, alkaline ion, organic ion, sodium ion, zinc ion, calcium ion, or ammonium ion.

In one or more embodiments, the polymer or polymer blend used to form the outer shell (the outer shell material) of the structured filament of the present invention will comprise one or more of ionizable segments. In one or more of these embodiments, the polymer or polymer blend used to form the outer shell will comprise from about 0.01 mol % to about 10 mol % ionizable segments. In some embodiments, the outer shell material will comprise from about 0.1 mol % to about 10 mol %, in other embodiments, from about 1 mol % to about 10 mol %, in other embodiments, from about 2 mol % to about 10 mol %, in other embodiments, from about 3 mol % to about 10 mol %, in other embodiments, from about 5 mol % to about 10 mol %, in other embodiments, from about 7 mol % to about 10 mol %, in other embodiments, from about 0.01 mol % to about 8 mol %, in other embodiments, from about 0.01 mol % to about 6.0 mol %, and in other embodiments, from about 0.01 mol % to about 4.0 mol % ionizable segments.

In one or more embodiments, the polymer or polymer blend used to form the outer shell of the structured filament of the present invention will comprise one or more of crystalline segments. In one or more of these embodiments the outer shell material will comprise from about 2 mol % to about 100 mol % crystalline segments. In some embodiments, the outer shell material will comprise from about 5 mol % to about 100 mol %, in other embodiments, from about 15 mol % to about 100 mol %, in other embodiments, from about 25 mol % to about 100 mol %, in other embodiments, from about 35 mol % to about 100 mol %, in other embodiments, from about 45 mol % to about 100 mol %, in other embodiments, from about 65 mol % to about 100 mol %, in other embodiments, from about 2 mol % to about 80 mol %, in other embodiments, from about 2 mol % to about 60 mol %, in other embodiments, from about 2 mol % to about 50 mol %, in other embodiments, from about 2 mol % to about 40 mol %, and in other embodiments, from about 2 mol % to about 20 mol % crystalline segments. In some embodiments, the polymer or polymer blend used to form the outer shell is partially crystalline after printing.

In various embodiments, the outer shell of the structured filament may comprise ionomers, polyolefins, nylons, polyethylene terephthalate (PET), crystalline polyesters, poly(urethanes), polytetrafluoroethene (PTFE), or a combination or blend thereof. In some embodiments, the outer shell of the structured filament may comprise olefin ionomer, zinc neutralized poly(ethylene-co-methacrylic acid), SURLYN™ 9910 (DuPont de Nemours, Inc., Wilmington, Del.), NUCREL™ (Dow, Midland Mich.), ELTEX™ (Ineos, London, UK), PRIMACORE™ (SK Global Chemicals, Seoul, Korea), high density polyethylene, SUNTEC™ 5161 (Asahi Kasei, Japan), ADSYL™ 5C37F (LyondellBasell Chemicals Company, Rotterdam, Netherlands), or a combination thereof.

The glass transition temperature (T_{g}) and the crystallization temperature (T_{c}) of the polymer or polymer blend used to form the outer shell of the structured filament of the present invention will be lower than the T_{g} of the polymer or polymer blend forming the inner core of those structured filaments. In one or more embodiments, the polymer or polymer blend forming the outer polymer shell of the structured filament of the present invention will have a T_{g} of from about 40° C. to about 150° C. In some embodiments, the polymer or polymer blend forming the outer polymer shell of the structured filament will have a T_{g} of from about 45° C. to about 150° C., in other embodiments, from about 60° C. to about 150° C., in other embodiments, from about 75° C. to about 150° C., in other embodiments, from about 100° C. to about 150° C., in other embodiments, from about 125° C. to about 150° C., in other embodiments, from about 40° C. to about 130° C., in other embodiments, from about 40° C. to about 110° C., in other embodiments, from about 40° C. to about 90° C., in other embodiments, from about 40° C. to about 70° C., and in other embodiments, from about 40° C. to about 55° C. Here, as well as elsewhere in the specification and claims, individual range values can be combined to form additional non-disclosed ranges. The relatively low T_{g} of the outer polymer shell enables improved interdiffusion of polymers between adjacent printed layers.

In one or more embodiments, the polymer or polymer blend used to form the outer shell of the structured filament of the present invention will comprise one or more of crystalline segments and will have a crystallization temperature (T_{c}) of from about 40° C. to about 150° C. In some embodiments, the polymer or polymer blend forming the outer polymer shell of the structured filament will have a T_{c} of from about 45° C. to about 150° C., in other embodiments, from about 60° C. to about 150° C., in other embodiments, from about 75° C. to about 150° C., in other embodiments, from about 100° C. to about 150° C., in other embodiments, from about 125° C. to about 150° C., in other embodiments, from about 40° C. to about 130° C., in other embodiments, from about 40° C. to about 110° C., in other embodiments, from about 40° C. to about 90° C., in other embodiments, from about 40° C. to about 70° C., and in other embodiments, from about 40° C. to about 55° C. Here, as well as elsewhere in the specification and claims, individual range values can be combined to form additional non-disclosed ranges.

The polymer or polymer blend forming the core of the structured filament will have a solidification temperature that is higher than the solidification temperature of the polymer or polymer blend used to form the outer shell portion of the structured filament. The “solidification temperature” of a polymer or polymer blend is the temperature at which the molten polymer or polymer blend solidifies and, as used herein, will be the higher of its glass transition temperature (T_{g}) and its crystallization temperature (T_{c}), if any. This insures that the core material is free to move within the shell material as they solidify and harden. The polymer or polymer blend forming the core of the structured filament of the present invention will have a glass transition temperature (T_{g}) that is higher than the T_{g} and/or T_{c} of the polymer or polymer blend used to form the outer shell portion of the structured filament.

In one or more embodiments, the polymer or polymer blend forming the core of the structured filament will have a glass transition temperature (T_{g}) of from about 5° C. to about 260° C. higher than the solidification temperature (i.e., the higher of the T_{g} and T_{c}) of the polymer or polymer blend used to form the outer shell portion of the structured filament. In some embodiments, the polymer or polymer blend forming the core of the structured filament will have a glass transition temperature (T_{g}) of from about 10° C. to about 200° C., in other embodiments, from about 10° C. to about 150° C., in other embodiments, from about 10° C. to about 100° C., in other embodiments, from about 5° C. to about 50° C., in other embodiments, from about 25° C. to about 260° C., in other embodiments, from about 50° C. to about 260° C., in other embodiments, from about 75° C. to about 260° C., in other embodiments, from about 100° C. to about 260° C. and in other embodiments, from about 125° C. to about 260° C. higher than the solidification temperature of the polymer or polymer blend used to form the outer shell portion of the structured filament.

In some embodiments, the polymer or polymer blend forming the core of the structured filament will have a T_{g} that is from about 5° C. to about 75° C. higher than the solidification temperature of the polymer or polymer blend used to form the outer shell portion of the structured filament. In some embodiments, the polymer or polymer blend forming the core of the structured filament will have a T_{g} that is from about 60° C. to about 75° C. higher than the T_{g} of the polymer or polymer blend used to form the outer shell portion of the structured filament. In some embodiments, the polymer or polymer blend forming the core of the structured filament will have a T_{g} that is at least 5° C. higher than the T_{g} of the polymer or polymer blend used to form the outer shell portion of the structured filament. Here, as well as elsewhere in the specification and claims, individual range values can be combined to form additional non-disclosed ranges.

The relative composition of the polymers making up the inner core and the outer shell may vary depending upon the particular application, but the composition of the inner core should be high enough to provide the required stiffness and rigidity to the printed structure, but not so high (i.e., make the shell composition so low) as impair the ability adjacent outer shells of the filaments being printed to fuse or weld together to form the 3D structure being printed and/or limit the functionality of the crystalline and/or ionic groups that strengthen the interface between the printed layers. In various embodiments, the inner core will comprise from about 35% to about 75% of the volume of the structured filament. In some embodiments, the inner core will comprise from about 40% to about 75%, in other embodiments, from about 45% to about 75%, in other embodiments, from about 50% to about 75%, in other embodiments, from about 55% to about 75%, in other embodiments, from about 60% to about 75%, in other embodiments, from about 35% to about 66%, in other embodiments, from about 35% to about 55%, in other embodiments, from about 35% to about 45% of the volume of the structured filament. In some embodiments, the inner core will comprise from about 45% to about 60% of the volume of the structured filament. Here, as well as elsewhere in the specification and claims, individual range values can be combined to form additional non-disclosed ranges.

The diameter of the structured filament of the present invention is not particularly limited and may have any suitable diameter for FFF or other similar types of 3D printing. In some embodiments, the structured filament of the present invention may have a diameter of from about 1.5 mm to about 3.5 mm prior to 3D printing, depending upon the particular 3D printer being used. In some embodiments, the structured filament of the present invention will have a diameter of about 1.75 mm prior to 3D printing. In some embodiments, the structured filament of the present invention will have a diameter of about 3.00 mm prior to 3D printing. As will be understood by those of skill in the art, the structured filament of the present invention may, in some embodiments, be drawn out to a smaller diameter during the 3D printing process.

In one or more embodiments, structured filament of the present invention may be annealed using methods commonly known in the art, provided that the structured filament is not heated above the solidification temperature of the material used for the inner core of the structured filament.

As set forth above, structured filaments of the present invention may be printed using FFF to form 3D structures having excellent impact resistance in comparison to its individual components, since energy is dissipated by delamination of the shell from the core near the crack tip, while the core remains intact to provide stability to the structure after impact. In addition, any energy from the impact dissipated by the delamination of the shell from the core will be unavailable to separate the welds between the adjacent structural fibers of the 3D printed structure. As will be apparent to those of skill in the art, there is will generally be some degree of adhesive force between the inner core and the outer shell and this mechanism requires that this adhesive force is less than the force necessary to break the welds between the filaments in the printed structure or propagate a crack through the outer core. As used herein, the term “adhesive force” refers to the force required to separate the materials forming the core from the materials forming the outer shell after they have been coextruded together to form the filament and printed using FFF.

The amount of adhesive force between the core material and the shell material in the structured filaments of the present invention is not particularly limited provided that is less than the minimum force necessary to break the welds between the filaments in the printed structure or propagate a crack through the outer core, as set forth above. In some embodiments, the adhesive forces between the core and shell material result from partial miscibility between the materials at their interface. As will be apparent to those of ordinary skill in the art, the higher the adhesion force between the core and the shell, the greater the amount of energy that can be dissipated when the core and shell delaminate. This energy dissipation will, as set forth above, greatly increase the impact strength of the printed 3D structure, provided that none of the welds between the shells of the filaments break first. Depending on the shape of the structure and various production conditions, the weld strength in the 3D printed structure may not be uniform throughout the structure and to get the energy dissipation benefit from the core-shell delamination, the adhesive force should be less than weld strength of the structure at its weakest point.

The structured filament of the present invention may be formed using any method known in the art for forming core-shell structured filaments including without limitation, co-extrusion and wire coating techniques. In one or more embodiments, the structured filament of the present invention may be formed using a co-extrusion process. In some of these embodiments, the structured filament of the present invention may be formed using the co-extrusion apparatus 10 shown in FIG. 1. As can be seen, co-extrusion apparatus 10 comprises a first extruder 12 and a second extruder 14 in fluid communication with a co-extrusion die 16 which produces a structured filament 18 having an inner core 20 and an outer shell 22, which is drawn out by a traction system 24. In the embodiment shown in FIG. 1, first extruder 12 and second extruder 14 both comprises a hopper 26,28, a screw 30,32, a first heating zone 34,36, a second heating zone 38,40, a third heating zone 42,44, and a melt pump 46,48. As will be apparent to those of skill in the art, a first polymer or polymer blend 50 for forming the inner core 20 and a second polymer or polymer blend 52 for forming the outer shell 22 are fed into first extruder 12 and second extruder 14, respectively through a corresponding hopper 26,28. In these embodiments, the first polymer or polymer blend 50 and second polymer or polymer blend 52 are melted and heated as they are moved through the first 34,36, second 38,40 and third heating zones 42,44, to melt pumps 46,48 by screws 30,32. In one or more embodiment, melt pumps 46,48 may be heated.

The extrusion temperatures for first polymer or polymer blend 50 and second polymer or polymer blend 52 are not particularly limited, provided that they are high enough to melt the polymer or polymer blends (i.e. over the T_{g}), but below their degradation temperature (T_{d}). In one or more embodiments, the extrusion temperatures first polymer or polymer blend 50 and second polymer or polymer blend 52 will be from about 20° C. to about 50° C. above their T_{g}. In various embodiments, the extrusion temperatures used for the first and second polymers or polymer blends will generally be comparable to their printing temperatures.

As will be apparent, co-extrusion die 16 of co-extrusion apparatus 10 is configured simultaneously extrude the first polymer or polymer blend 50 through a generally round inner opening 54 and second polymer or polymer blend 52 through a generally ring-shaped outer opening 56 surrounding the generally round opening 54 to provide a core-shell structured filament at nozzle 58. In some embodiments, co-extrusion die 16 may be standard co-extrusion die with a circular opening (diameter=2 mm). In some embodiments, co-extrusion die 16 may be as set forth in U.S. patent Ser. No. 10/724,197 and European Published Application No. EP0203771A2, the disclosures of which are incorporated herein by reference in their entirety. As will be apparent, the melt pump 46 in the first extruder 12 is connected to the inner opening 54 of co-extrusion die 16 and the melt pump 48 in the second extruder 14 is connected to the outer opening 56 of co-extrusion die 16. In one or more embodiment, co-extrusion die 16 is heated to keep the first polymer or polymer blend 50 and second polymer or polymer blend 52 from cooling during the extrusion process.

The volumetric output from both the first and second extruders 12,14 is independently controlled by melt pumps 46,48. These melt pumps 46,48 both maintain a constant filament diameter in the product and control the relative composition of the filaments produced and hence, the thickness of the shell. By individually determining the relationship between volumetric throughput and motor speed for each melt stream at their respected processing temperatures, the relative volume fractions of the core-shell filament can be precisely controlled.

In some embodiments, structured filament 18 may be drawn out by a traction system 24 after it exits nozzle 58, as is known in the art, to arrive at filament having a desired diameter and shell thickness. In various embodiments, the structured filaments may be quenched or cooled, as is known in the art. In some embodiments, the structured filaments are quenched in a room temperature water bath and drawn onto a take-up wheel.

In some other embodiments, the structured filament of the present invention may be formed using wire coating techniques, as known in the art, by treating the inner core filament as the wire and the outer shell if it were the coating applied to the wire. In these embodiments, the core material is formed into a fiber by extrusion or other suitable method and drawn down to a diameter desired for the inner core of the structured filament. The shell material is then applied to the core fiber as a liquid to a desired thickness using any one of numerous methods known in the aft for that purpose, and solidifies to form the outer shell of the structured filament of the present invention. In various embodiments, the structured filament of the present invention may be formed using any suitable wire coating techniques, including but limited to those shown in U.S. Pat. No. 3,412,354, U.S. Published Application No. 2014/0134335A1, and Lafleur, P. G., Vergnes, B., Lafleur, P. G. and Vergnes, B. (2014). Wire Coating and Cable Insulation. In Polymer Extrusion (eds P. G. Lafleur and B. Vergnes). doi:10.1002/9781118827123.ch7, the disclosures of which are incorporated herein by reference in their entirety. One of ordinary skill in the art will be able to form the structured filaments of the present invention using wire coating techniques without undue experimentation.

As set forth above, the structured filaments of the present invention may be annealed using methods commonly known in the art, provided that the structured filament is not heated above the solidification temperature of the material used for the inner core of the structured filament.

In a second aspect, the present invention is directed to 3D printed structures formed by fused filament fabrication of the core-shell structured filament described above. It has been found that 3D printed structures formed by fused filament fabrication of the core-shell structured filaments of the present invention have better dimensional accuracy, warp resistance, and impact resistance than comparable to structures made from either of their component polymers.

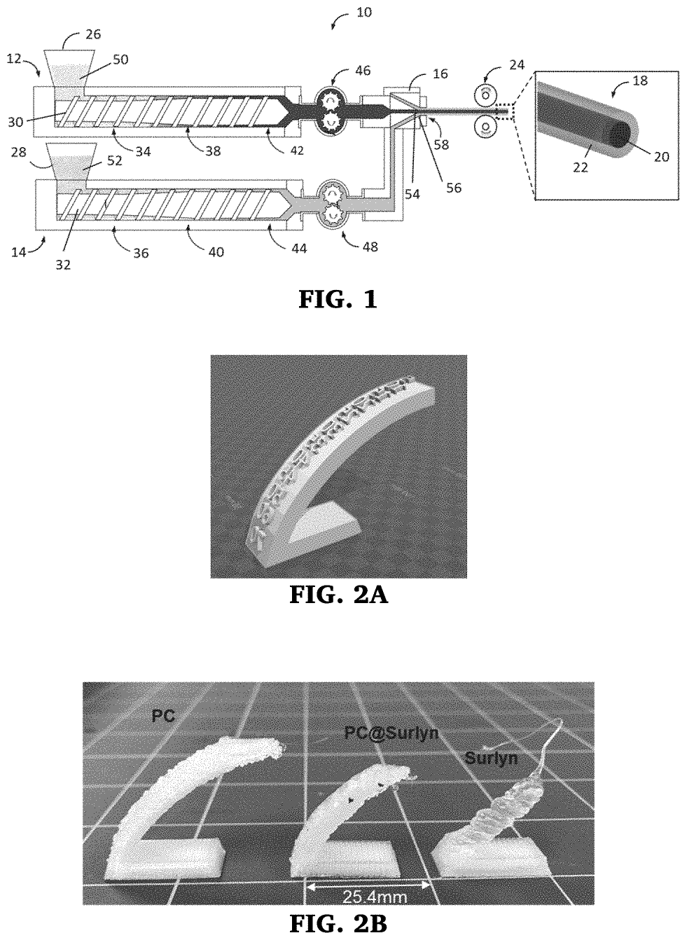

In FFF 3D printing, as in all additive manufacturing, structures are printed from data generated from 3D computer models created in any one of many commercially available software package designed for that purpose. The printing process with the core-shell filaments of the present invention is identical to standard FFF printing, where the filament is fed into a heated nozzle where it is melted and then deposited on the build platform. In various embodiments, the 3D printed structures of the present invention have improved dimensional accuracy compared to 3D printed structures formed from comparable filaments made from either the core or the shell component polymers. (See FIGS. 2A-B) As used herein, the term dimensional accuracy refers to the degree to which the 3D printed shape is the same as the digital model from which the shape was based. While not wishing to be bound by theory, it is believed that printing of the core-shell structured filaments of the present invention at intermediate temperatures permits solidification of the core to form a solid framework, while the melted shell material, held in place by capillary forces, has time to flow to form a structure with good accuracy.

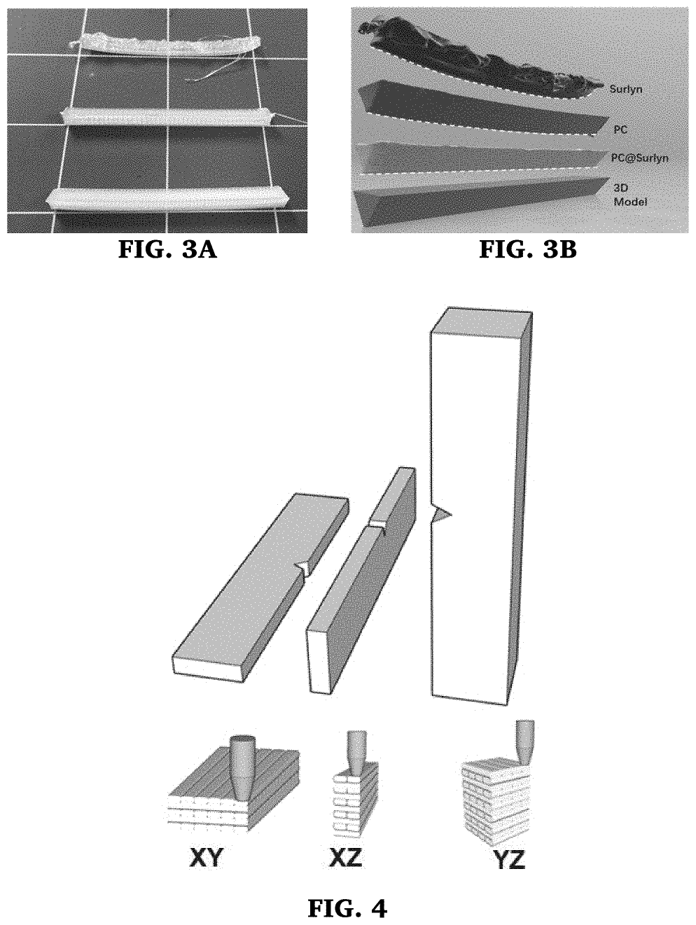

Further, in various embodiments, the 3D printed structures of the present invention resist warping when compared to 3D structures made from either of their component polymers. (See, FIGS. 3A-B). FIG. 3B illustrates a comparison between the original 3D file and the 3D scanned image of the printed wedge-shaped bars made using structured filaments of the present invention, and filaments made from each of their component polymers. It demonstrates that the geometry of the original 3D-model file is replicated by the printing of core-shell structured filaments of the present invention, while the bars printed with individual component shows bent length or distorted edges. This bending is associated with the residual stress developed in the printed structure as it cools and it is believed that the isolation of the high T_{g} and high modulus core material of the structured fibers of the present invention decreases the stress transfer on cooling during the 3D printing process. The limited bending in the core-shell materials is particularly remarkable in embodiments like the one shown in FIG. 3A, where the outer shell material is semicrystalline (15.9% of polyethylene segments), since there the presence of crystalline segments leads to some contraction on crystallization. While not wishing to be bound by theory, it is believed that this advantage stems from the solidification process. Both components of the structured filaments of the present invention are printed in their melt state but, as set forth above, the inner core material has a significantly higher solidification temperature and will much more rapidly than the outer shell material. As a result, when the inner core material solidifies it is free to move within the melted outer shell material and changes in its volume do not create stress within the overall structure. Moreover, as the inner core material continues to cool, the typical stresses associated with the thermal expansion can be dissipated by the surrounding melt. Finally, when the shell material cools and begins to solidify, it does so around the already solidified more material which can provide the necessary rigidity to prevent, or at least minimize, any warpage as the outer shell material crystallizes.

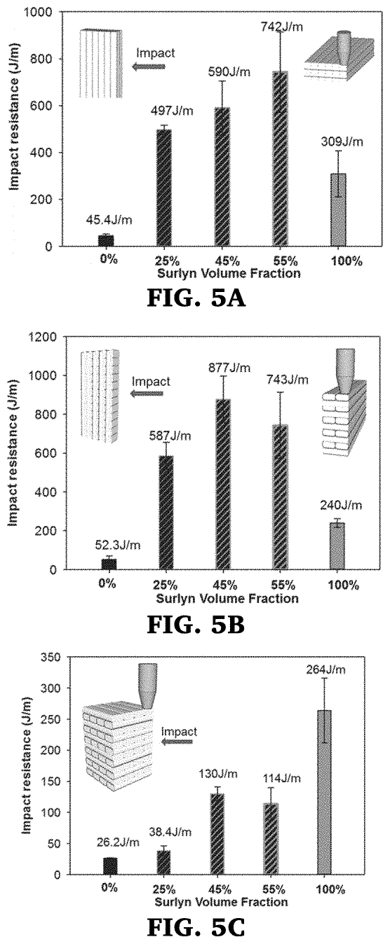

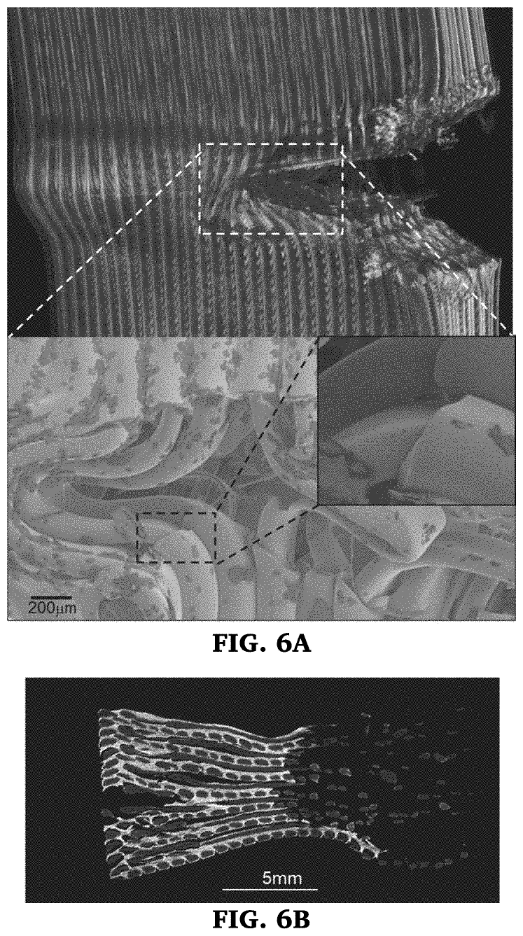

Finally, as set forth above, the 3D printed structures of the present invention have greatly improved impact resistance compared to 3D printed structures formed from comparable filaments made from either the core or the shell component polymers. The printing orientation and composition of the core-shell filament are both important factors in determining the available mechanisms for energy dissipation in the 3D-printed structures of the present invention. As will be understood by those of skill in the art, the orientation of the object during the print can dramatically influence the observed properties of these types of 3D printed structures. A structure printed using FFF, will have three different orientations as shown in FIG. 4 where the printer hotend is rastered in the XY plane as the build platform moves in Z as the layers are built. As can be seen in FIGS. 5A-C, the 3D printed structures of the present invention have greatly improved impact resistance compared to 3D printed structures formed from comparable filaments in the XY (flat) and XZ (edge-on) orientation. Use of the structured filament of the present invention provides reinforcement from the continuous inner core along the direction of fiber, thus the impacted specimen does not break when printed in XY and XZ orientation. Further, in some embodiments, additional energy may be dissipated by the plastic deformation of the inner core fibers leading to toughening, as shown in FIGS. 6A-B, 7B, 8C, and 9.

The improvements were found to be much more modest in the YZ (end-on) orientation because the inner core runs parallel to the impact direction (See, FIG. 5C), and there is no normal component for the core to deform to limit the crack propagation. In all orientations, however, it has been found that delamination of outer shell from the inner core and stretching of inner core fibers dissipate the energy from the impact loading, which can provide unprecedented impact resistance for 3D printed structure. In some embodiments, the 3D printed structures of the present invention have shown impact resistance of 800 J/m or more.

Interestingly, it has been found that the tremendous increase in impact resistance found with the core-shell filaments of the present invention only modestly influences the elastic moduli of the printed parts for the core-shell combinations examined. In one or more embodiments, the initial modulus of the core-shell 3D structures of the present invention will be modestly reduced in comparison to 3D structures made from the core material alone, but significantly greater than that of structures printed from the shell material alone. Moreover, the 3D structures of these embodiments of the present invention will generally have a yield point similar to the failure strain for the 3D structures printed from the core material alone and a stiffening post yield consistent with cold-drawing. This combination of strain softening at yielding followed by a cold-drawing in a strain-hardening manner is often observed in tensile test of structures formed by compression-molding, so the tensile behavior of the parts printed from the core-shell filaments appear of the present invention appear to be more aligned with expectations of the mechanical performance of the core materials when formed using traditional manufacturing techniques

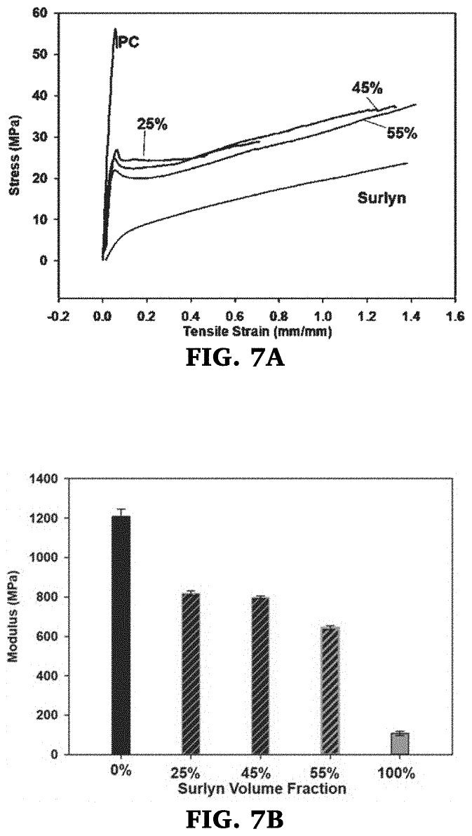

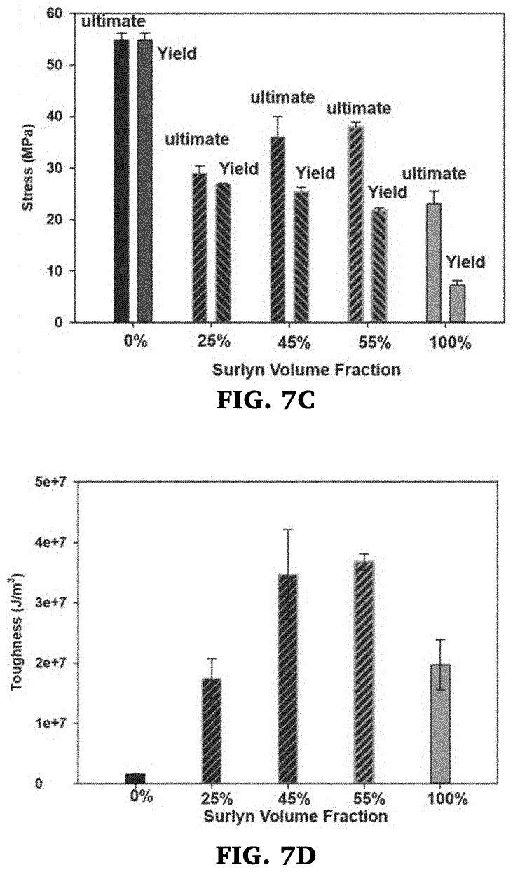

Similarly, the tensile strength of the core-shell filaments of the present invention will generally be between that of core material and the shell material (See, e.g., FIG. 7C; Table 3, below). The area under the tensile curve provides insight into the toughness of the printed parts as quantified by the energy absorption before fracture. This tensile toughness (FIG. 7D) indicates improvements from the core-shell architecture, further confirming the synergistic improvement in toughness determined from impact properties (See, FIGS. 2A-C).

### EXPERIMENTAL

In order to more fully illustrate and reduce the invention to practice, a series of core-shell structured filaments according to one or more embodiments of the present invention were formed using an amorphous polycarbonate material as the core and an ionomer of partially zinc neutralized polyethylene-co-methacrylic acid as the shell material and then printed using FFF into 3D structures, which were then tested for warping, printing accuracy and impact resistance.

Materials and Characterization.

Bisphenol-A polycarbonate (PC, Covestro Inc., MAKROLON™ 3208) and an ionomer of partially zinc neutralized polyethylene-co-methacrylic acid (Dupont, SURLYN™ 9910) were used as the polymers for 3D printing. Prior to extrusion or 3D-printing, pellets (as obtained from Covestro, Inc., and Dupont) or filaments were dried in a vacuum-oven for 12 h to remove residual water (PC at 110° C.; Surlyn 9910 at 60° C.), which can lead to a reduction in the molecular weight of the PC during melt processing. Differential scanning calorimetry (TA Instruments DSC, Model Q2) with hermetic aluminum pans was performed at a heating and cooling rate of 10° C. min⁻¹ under a nitrogen atmosphere was used to assess the thermal properties.

Filament Extrusion.

Filaments of pure PC or Surlyn were extruded using a HAAKE single screw extruder (Model Rheomex 252p) that was equipped with a gear pump and a simple circular die (diameter=2.2 mm). The temperature profile used for extrusion of each filament is shown in Table 1. Two single-screw extruders (Rheomex 252p and Akron Extruder M-PAK 150) with a co-extrusion die with a circular opening (diameter=2 mm) as shown in FIG. 1 were used to fabricate the core-shell PC@Surlyn filaments. Each extruder was connected to a separate gear pump to control the flow rate ratio of the PC and Surlyn melts (25%, 45% and 55% Surlyn). The extruded filaments were quenched in a room temperature water bath and drawn onto a take-up wheel. The diameter of the extruded filament was drawn down to approximately 1.7 mm by controlling the take-up speed relative to the extrusion rate. The diameter of the filaments was controlled to 1.70±0.03 mm.

TABLE 1
Temperature Profile for Filament Extrusion

| | | | | | Gear | |
|---|---|---|---|---|---|---|
| | | Zone 1 | Zone 2 | Zone 3 | Pump | Die |
| Filament | | (° C.) | (° C.) | (° C.) | (° C.) | (° C.) |
| PC | | 280 | 290 | 275 | 280 | 240 |
| Surlyn | | 220 | 230 | 240 | 240 | 200 |
| PC@Surlyn | PC | 280 | 290 | 275 | 280 | 220 |
| | Surlyn | 220 | 230 | 240 | 240 | |

3D Printing.

A customizable 3D printer, Cartesio 3D printer Model: W09, equipped with an E3D-v6 (1.75 mm-type) hot-end (liquefier) assembly that was heated using a 24V-40W cartridge heater (E3D) and a 0.4-mm nozzle was used to print the samples. For the impact tests, samples in accordance with ASTM-D256 were 3D-printed at 3 different orientations as shown in FIG. 4. The thickness of the samples printed in XY and XZ direction was 3 mm, while the thickness in the YZ direction was 12.7 mm. All samples in XY and XZ direction were printed with extrusion temperature of 280° C. at 20 mm/min. Due to the localization of the heat from the extruder in the YZ direction, these samples were printed at 260° C. at 10 mm/min in order to maintain.

For tensile tests, samples were 3D-printed in XY direction with a thickness of 1.5 mm in accordance with ASTM-D638V (2014). For production of the tensile bars, the print-bed was covered with Kapton tape and heated to 100° C. during the printing. A thin layer of washable PVA adhesive (Elmer's glue stick) was applied to the Kapton to enhance adhesion of the part to the print bed. Each sample were built in an 0°/90° infill pattern with a 100% infill density. After the build, the part was rinsed with water to remove any residual PVA adhesive.

Characterization.

The notched Izod resistance of the 3D-printed samples are notched with a 2.54 mm-deep tapered notch using a standard notch cutter was measured following ASTM D-256. A standard ASTM D-256 Izod pendulum impact machine used a 5-lb load for the impact tests. Tensile properties of the 3D printed samples were tested using an Instron 5567 with a crosshead velocity of 10 mm/min during the tensile experiment. The structure of the impacted samples was assessed with an X-ray MicroCT scanner (Bruker Skyscan1172) operating at 50 kV/200 μA. The difference in electron density between PC and Surlyn allowed the structure of core and shell to be resolved with X-Ray tomography. Transmission X-ray images were recorded at 0.4° rotational steps over 180° of rotation. The NRecon software was used to reconstruct the cross-section image, which were imported into Skyscan CT Analyzer (V1.1) to construct the full 3D-images. Field-emission scanning electron microscopy (FESEM, JEOL-7401) was used to further assess the structure of the objects after impact. Before the SEM imaging, the samples were sputter coated with silver for good surface electrical conductivity. The shape of the 3D printed parts was interrogated with an ATOS Core 200 3D scanner (GOM) Before scanning, the sample was primed (RUST-OLEUM White Primer) and decorated with 6 reference points to improve the geometry capture. The samples were scanned from both the top and bottom. The 3D images were reconstructed by combining these two scans using ATOM Hotfix 6 software.

### Results and Discussion

The enhancement in the mechanical properties of the 3D printed parts relies on the improvement in the interfacial properties between printed layers enabled by the structured filaments. FIG. 1 illustrates the extrusion process by which the structured filaments were produced. Both polycarbonate (PC), which comprises the core, and Surlyn, which is an olefin ionomer and comprises the shell, are melted in standard extruders with the volumetric output from each extruder controlled by melt pumps. These melt pumps both maintain a constant filament diameter in the product and to control the relative composition of the filaments produced and hence the thickness of the shell. By individually determining the relationship between volumetric throughput and motor speed for each melt stream at their respected processing temperatures, the relative volume fractions of the core-shell filament can be precisely controlled. The two melt streams are combined in a co-extrusion die to generate the core-shell filaments. These thermoplastic structured filaments are then used as the feedstock for 3D printing via FFF.

Printing of Objects Using Structured Filaments.

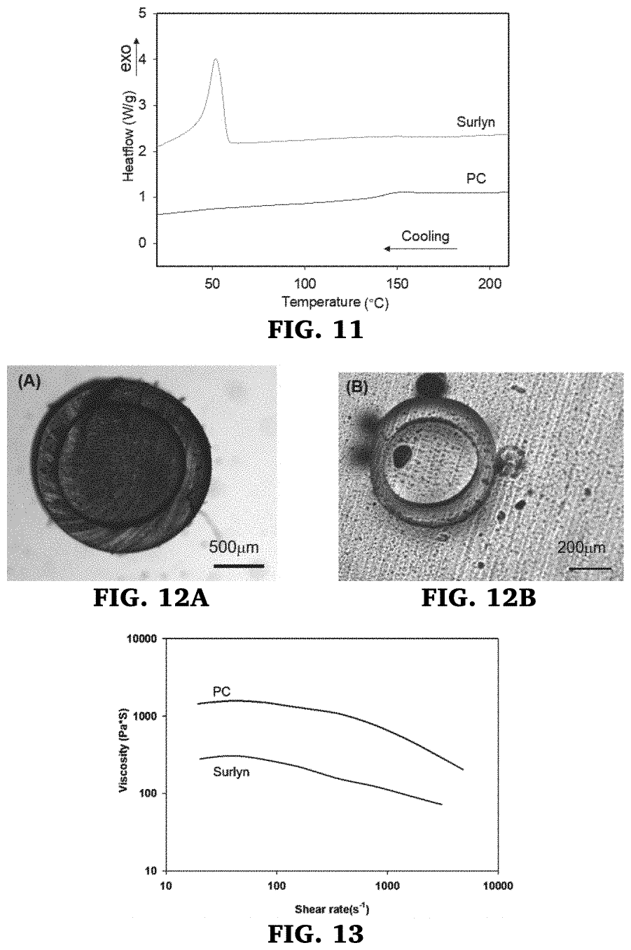

FIG. 10A illustrates schematically the printing process for the structured core-shell filament. The printing process with these core-shell filaments is identical to standard FFF printing where the filament is fed into a heated nozzle where it is melted and then deposited on the build platform. The extrusion temperature for the core-shell material is set to be the same as an optimized temperature for printing of simple filaments of PC. This temperature is greater than can accurately print the Surlyn alone (FIGS. 2A-B) due to the approximate 90° C. lower thermal transition in Surlyn in comparison to PC (FIG. 11) for solidification. This inability to accurately print Surlyn at the extrusion conditions is associated with the flow of the material, which leads to significant deviations in the shape for the pure filament, but this ability of the Surlyn to flow (diffuse) substantially at these print conditions should act to improve the quality of the interface between printed layers. It should be noted that these print conditions are not suitable for printing complicated geometries with pure Surlyn, while these are optimize for the elastic modulus of pure PC while maintaining the shape fidelity.

FIG. 10B illustrates the X-ray OCT image of a printed part using PC@45% Surlyn filament, where the PC is the core and the Surlyn shell is 45 vol % of the filament. Due to the difference in electron density, the bright Surlyn shell surrounding the PC core in the printed layers can be clearly distinguished. The shell remains conformal around the PC core even as the total diameter decreases from 1.65 mm to 0.61 mm as the filament is extruded in the 3D print process. To better illustrate that the extruded materials are consistent with the initial filament, cross-section images of the co-extruded filaments and corresponding 3D printer-extruded filament are compared in FIGS. 12A-B. After being extruded by the 3D-printer, the dimension of core decreases from 1.22 mm (54.6 vol % PC) to 0.45 mm (54.4 vol % PC). This indicates that the volume fraction of the PC remains constant during the 3D printing process. This consistency is despite the differences in the rheological properties of PC and Surlyn at 280 C (printing temperature) as shown in FIG. 13, where the viscosity of PC is higher than that of Surlyn. This configuration is favorable as the stress for high shear rate near the wall is lowered by the low viscosity shell. Careful examination of the micrograph in FIG. 10B illustrates that there are no observable gaps or voids in the printed part, which is consistent with the flow of the Surlyn to fill these gaps. A 0.23% unfilled volume fraction is obtained by integrating the void area across the sample with a series of CT cross-section images. Despite the high flowability of Surlyn at the processing temperature, the shape of the printed object is remarkably close to the digital input with no statistical difference in the fidelity of the shape between the core-shell and pure PC filaments. One additional advantage of the core-shell material in comparison to the pure materials is the warpage of the final part. As shown in FIG. 3A, a printed wedge-shaped bar using PC@45% Surlyn remains flat after removal from the build platform, while bars printed with the individual components exhibit significant bending.

FIG. 3B illustrates a comparison between the original 3D file and the 3D scanned image of the printed wedge-shaped bars. It demonstrates that the geometry of the original 3D-model file is replicated by the printing of core-shell filament, while bars printed with individual component shows bent length or distorted edges. This bending is associated with the residual stress developed in the part; the isolation of the high T_{g} and high modulus PC decreases the stress transfer on cooling during the 3D printing process. The limited bending in the core-shell materials is even more remarkable given the semicrystalline nature (15.9% of polyethylene segments) of the Surlyn that leads to some contraction on crystallization. This demonstrates that the structured filament can provide some advantages in terms of the printed structure fidelity. To explain the improved printed accuracy of the part, the solidification process and stress accumulation must be considered. For the PC@Surlyn filaments, both components are printed in the melt state and the PC solidifies much more rapidly than the Surlyn. The solidification of the PC occurs with the PC surrounded by a melt of Surlyn, so any volume changes associated by the PC are not transferred to the bulk structure as it is floating in the Surlyn melt to dissipate the stress. As the PC continues to cool, the typical stresses associated with the thermal expansion can be dissipated by the surrounding melt. The crystallization of the Surlyn tends to lead to major deformation of the structure for the pure Surlyn filaments, but the structure of objects from the core-shell appear to not be impacted by this crystallization. The high relative modulus of the PC core minimizes the deformation associated with the crystallization of the Surlyn due the energetic penalty associated with bending of the PC fiber core. This combination of properties minimizes the bending and deformation of the parts printed from the core-shell filaments.

Impact Properties from Structured Filaments.

When examining the properties of 3D printed parts, the orientation of the object during the print can dramatically influence the observed properties. Here three common print orientations as illustrated in FIG. 4 are examined, where the printer hotend is rastered in the XY plane as the build platform moves in Z as the layers are built. Table 2 shows the measured impart resistances for the 3D printed samples by impact orientation.

TABLE 2
Impact resistance of the 3D printed samples

| | PC | | 45% Surlyn | 55% Surlyn | Surlyn |
|---|---|---|---|---|---|
| | (J/m) | 25% Surlyn (J/m) | (J/m) | (J/m) | (J/m) |
| XY orientation | 45.4 ± 6.4 | 479 ± 20 | 590 ± 115 | 742 ± 170 | 309 ± 98 |
| XZ orientation | 52.3 ± 18.1 | 587 ± 68 | 877 ± 120 | 742 ± 171 | 240 ± 22 |
| YZ orientation | 26.2 ± 0.8 | 38.4 ± 7.5 | 130 ± 11 | 114 ± 26 | 264 ± 52 |

FIGS. 5A-C illustrates how the composition of the filament as well as the print orientation influence the impact resistance of the printed part. For the pure PC, the impact resistance of the 3D printed specimen is less than 60 J/m irrespective of the part geometry, which is greatly inferior to the standard reported properties of this PC from injection molded parts (807 J/m). This large decrease in the mechanical properties of 3D printed parts in comparison to their injection molded analogs is commonly reported and is one of the grand challenges associated with additive manufacturing. For the pure Surlyn, the impact resistance of the 3D printed part is much larger (300 J/m), but still less than the impact resistance for injection molded parts (362 J/m). The structured filaments in general provide a significant enhancement in impact resistance. As shown in FIG. 5A for the XY geometry, increasing the proportion of Surlyn within the structured filament leads to an increase in the impact resistance from 497 J/m with 25% Surlyn to a maximum of 742 J/m with 55% Surlyn. In this case, the core-shell material outperforms either of the individual components irrespective of the composition. This improvement in the impact properties with the core-shell structure is consistent with expectations based on the consensus view of the interfaces between layers being the limiting factor for the mechanical performance of 3D printed parts, but this concept has not been previously applied. The impact resistance of the PC@55% Surlyn exceeds the impact resistance of injection molded Surlyn, while it is within 10% of the injection molded PC.

FIG. 5B illustrates how changing the print geometry for the specimen to XZ affects the impact resistance. Interestingly, this geometry adversely affects the impact resistance for the pure Surlyn, but the impact resistance for PC@25% Surlyn and PC@45% Surlyn increases in comparison to the XY geometry. In this geometry, the specimen printed from PC@45% Surlyn exhibits the greatest impact resistance (877 J/m). This impact resistance significantly exceeds that of any other previously reported 3D printed polymer part and demonstrates the effectiveness of this core-shell approach to enhance the mechanical properties of parts printed by FFF. This impact resistance even exceeds that of the injection molded PC, which points to synergies in the impact properties through the use of the structured filament.

The weakest direction generally for FFF parts is in the YZ geometry and this is also true for the core-shell materials as shown in FIG. 5C. Unlike the other geometries, the impact resistance of the pure Surlyn exceeds that of the core-shell materials, but there remains a marked improvement for the PC@Surlyn in comparison to the pure PC. To explain this directional dependence, how the structures respond to impact must be understood.

Mechanisms for Energy Dissipation in 3D Printed Objects.

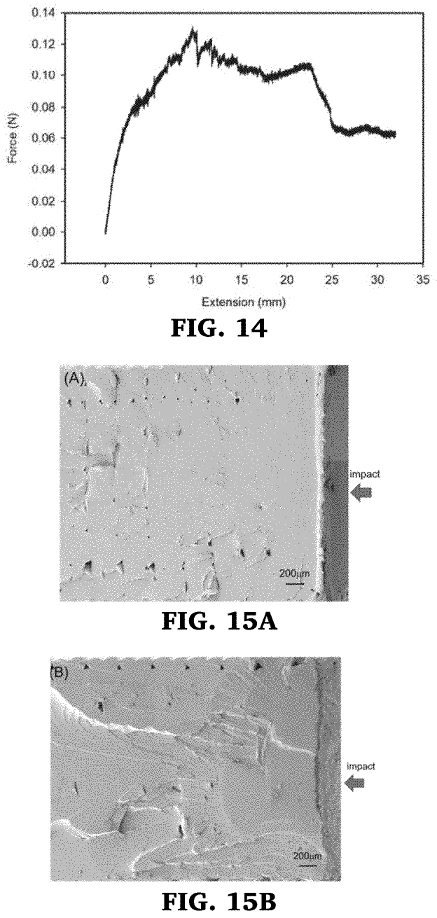

FIGS. 6A-B illustrates the structure of the damage zone after impact for a specimen printed at XY geometry with PC@45% Surlyn. The printed structured buckles through the sample near the crack tip (FIG. 6A (upper)), but the crack only propagates about 40% of the thickness of the specimen from a 2.67 kg impact event. This further demonstrates the efficacy of this core-shell design for enhancing the mechanical performance of 3D printed parts. Nearest to the crack tip, the PC core material is stretched and bridges across the crack. This buckling at the crack tip can be better resolved by SEM as shown in FIG. 6A (lower and callout). Careful examination of the buckled fibers in the impact zone indicates that they are thinner than the unbuckled regions at the edges. There is an abrupt change in thickness in the impact zone, which we attribute to debonding and delamination of the Surlyn from the PC core. As Surlyn and PC are immiscible, the adhesion between these two polymers is limited and thus this interface appears to be the weakest link in the printed part, not the weld line interface between subsequently printed layers, which tends to fail. To confirm the ease of delamination of the Surlyn from the PC core, a 90° peel test of thermally-welded PC/Surlyn films was performed (FIG. 14), which indicates that only a small force is required to delaminate PC and Surlyn. The failure of the Surlyn-PC interface on impact is consistent with our speculation that the high temperature to promote diffusion enabled by the core-shell filament and specific functionality of Surlyn promote a strong interface for the 3D printed parts. However, the delamination of the Surlyn from the PC will provide an additional energy dissipation mechanism for the 3D printed part.

Additionally, the buckled structure near the crack tip provides evidence of plastic deformation of the PC to further dissipate the energy of the impact. To confirm this delamination of the Surlyn for the fibers bridging the crack, the plane of the crack is examined with X-ray OCT as shown in FIG. 6B. In the crack region, the isolated fibers are only darker grey, associated with the PC, which is consistent with our expectation of delamination of the Surlyn. This structure is distinct from the intact region of the specimen where there is a bright continuous phase (Surlyn) surrounding the isolated dark grey phase (PC). These failure structures are only present in the parts printed with the core-shell filaments, whereas the fracture surfaces from pure PC or Surlyn (FIGS. 15A-B) are nearly flat, which indicates the crack propagates through the sample along the direction of impact. These results demonstrate a likely change in the failure mechanism when parts are printed with the core-shell filaments.

From a careful examination of the deformation zone after impact, energy dissipation mechanisms have been identified that explain the geometry dependence of the impact resistance for the core-shell materials (FIGS. 5A-C). When the PC core fibers run perpendicular to the impact direction (FIGS. 5A-B), the delamination of the Surlyn and the deformation of the PC fibers provide significant energy dissipation to toughen the printed structures. When the PC core is parallel to the impact direction (FIG. 5C), there is no normal component for the PC to deform to limit the crack propagation. Additionally, the PC/Surlyn interface is weaker than the weld lines, which provide a path for the crack to grow through the sample. Core-shell debonding can be observed at and near the crack tip (FIG. 9). This difference in the strength of the interface is responsible for the lower impact resistance of the core-shell materials in comparison to pure Surlyn (FIG. 5C).

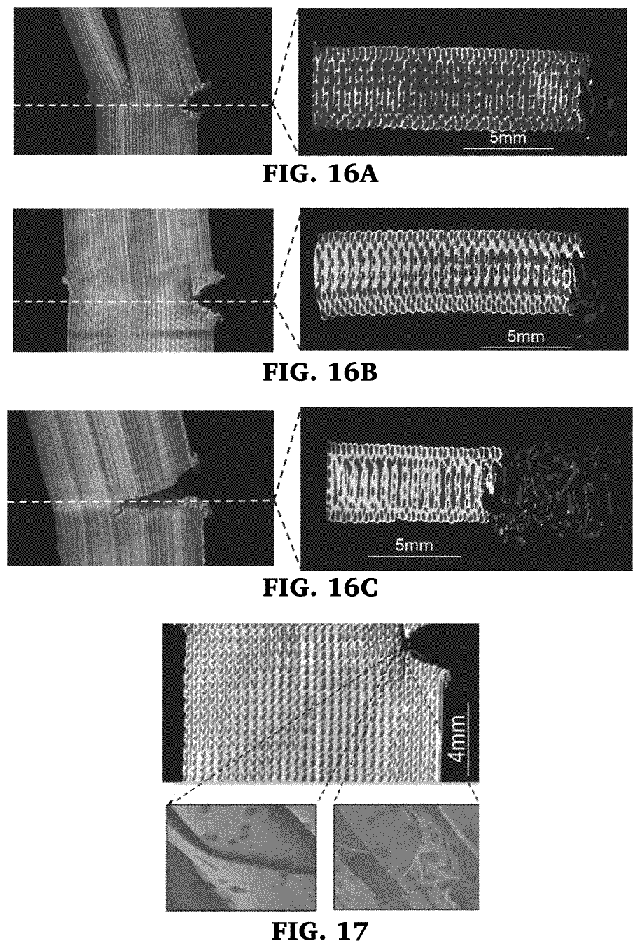

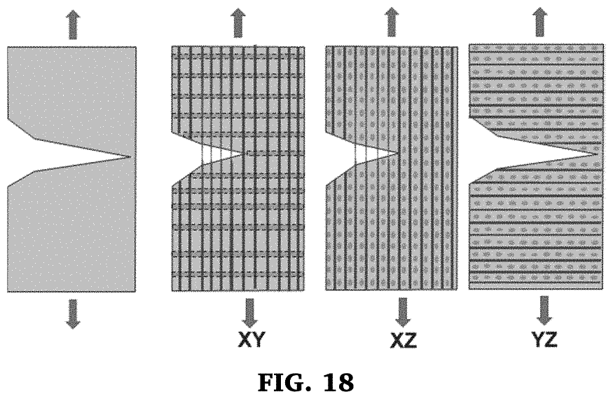

FIGS. 16A-C illustrates how the composition of the core-shell filament influences the deformation of the 3D printed specimen on impact as the thickness of the shell changes the observed impact resistance of the part. FIG. 16A shows the structure of the damage zone for a specimen printed at XZ geometry with PC@25% Surlyn. Instead of generating a crack propagating from the tip of notch (pre-crack), the impact event induces layer delamination of the core-shell perpendicular to the notch. This crack extends vertically through the sample, effectively breaking the upper part of the sample into two. This delamination is similar to fiber laminate composite, where this impact damage is caused by the mismatch in stiffness. As the PC is significantly stiffer than the Surlyn, this composite-like behavior appears to be dominating when the shell (Surlyn) content is small. Conversely using PC@45% Surlyn (FIG. 16B), neither a crack along the notch nor fully delaminated layers after the impact occurs, which illustrates the improved resilience of this composition. However, core-shell debonding is still observed in the cross-section, which indicates partial delamination as an energy dissipation mechanism (See, e.g., FIG. 17). Further increasing the Surlyn content (PC@55% Surlyn, FIG. 16C), leads to finite crack propagation along the notch direction after impact. In the damage zone, clean PC fibers free of Surlyn bridge across the crack. The different impacted zone structures suggest that the Surlyn/PC ratio is crucial for the enhancement of impact properties. At low PC content, matrix crack propagation is not fully inhibited by the structured filaments (FIG. 16C), while at low Surlyn content the printed part is susceptible to deflection from impact (FIG. 16A). PC@45% Surlyn specimen absorbs the highest energy (FIG. 5C) with the lowest deflection, which leads to synergistic impact properties in this PC/Surlyn composition. FIG. 18 schematically illustrates these mechanisms for impact resistance with the core-shell filaments. This structured filament concept could be applied to other materials to generate 3D printed objects with enhanced properties.

More commonly, the tensile properties of 3D printed parts are reported as the Young's modulus is less sensitive to a small density of defects and optimization around modulus is common. As such, the tensile properties of the parts printed with core-shell filaments were also examined. (See, Table 3, below). FIG. 7A shows the stress-strain curves for 3D printed samples printed from the different filaments. On uniaxial stretching, the PC sample fails immediately after yielding via brittle fracture. This very limited elongation at break for the 3D printed PC differs from the ductility of compression-molded tensile bars of analogous PC materials. Conversely, the part printed from Surlyn alone exhibits a low elastic modulus but the Surlyn can be elongated to more than double its initial dimensions. The stress-strain curve of 3D-printed Surlyn (FIG. 7A) exhibits elastomer-like behavior, which is similar to the reported tensile properties of other compression-molded polyethylene ionomers. However, the low modulus of the Surlyn part will lead to undesired deformation of the printed part at relatively low applied loads. The tensile performance of the parts printed from various compositions of PC@Surlyn filaments follows common features: (1) the initial modulus is modestly reduced in comparison to the pure PC, but significantly greater than pure Surlyn, (2) yield point similar to the failure strain for the pure PC, and (3) stiffening post yield consistent with cold-drawing. This combination of strain softening at yielding followed by a cold-drawing in a strain-hardening manner is often observed in tensile test of compression-molded polycarbonate, so the tensile behavior of the parts printed from the PC@Surlyn filaments appear to be more aligned with expectations of the mechanical performance of PC from traditional manufacturing (compression and injection molding) than the 3D printed PC material. FIG. 7B quantifies the differences in the elastic moduli for the 3D printed parts from different composition filaments. The elastic modulus of the Surlyn is approximately an order of magnitude less than that of the PC, but there is only approximately 25% decrease in the elastic modulus for the two PC@Surlyn which are majority PC. This suggests that the tremendous increase in impact resistance with the core-shell filaments only modestly influences the elastic moduli of the printed parts.

Similarly, the tensile strength of the core-shell filaments is between that of PC and Surlyn (FIG. 7C; Table 3). The area under the tensile curve provides insight into the toughness of the printed parts as quantified by the energy absorption before fracture. This tensile toughness (FIG. 7D) indicates improvements from the core-shell architecture, further confirming the synergistic improvement in toughness determined from impact properties (FIGS. 5A-C). The relative improvement in toughness is less from the tensile test, which is attributed to the rate dependencies in the mechanical properties of the PC and Surlyn.

TABLE 3
Tensile properties of the 3D printed samples

| | PC | 25% Surlyn | 45% Surlyn | 55% Surlyn | Surlyn |
|---|---|---|---|---|---|
| Modulus | 1207.4 ± 37. | 818.0 ± 14.1 | 798.2 ± 5.8 | 644.3 ± 11.2 | 109.0 ± 10.4 |
| (mPa) | | | | | |
| Ultimate tensile | 54.8 ± 1.4 | 28.9 ± 1.2 | 36.1 ± 120 | 37.9 ± 1.0 | 23.0 ± 2.6 |
| stress | | | | | |
| (mPa) | | | | | |
| Yield stress | 54.8 ± 1.4 | 26.9 ± 0.2 | 25.4 ± 0.8 | 21.7 ± 0.6 | 7.2 ± 1.0 |
| (mPa) | | | | | |
| Toughness | 1.56 ± 0.14 | 17.4 ± 3.3 | 34.7 ± 7.5 | 36.7 ± 1.3 | 19.7 ± 4.15 |
| (10⁶ J/m³) | | | | | |

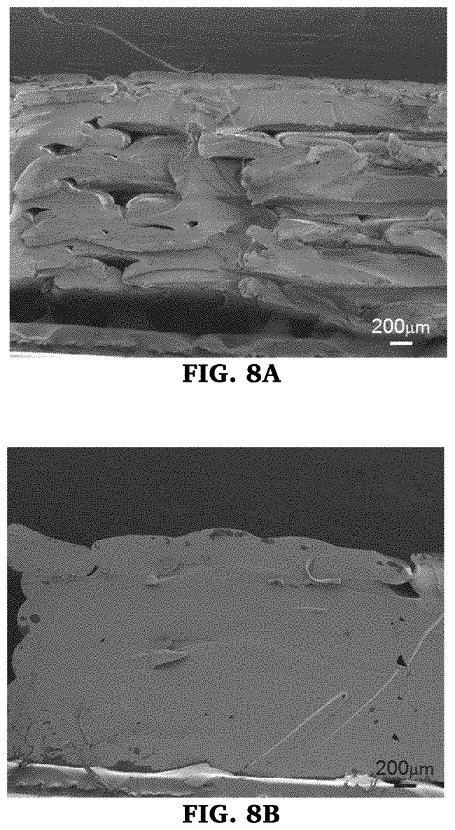

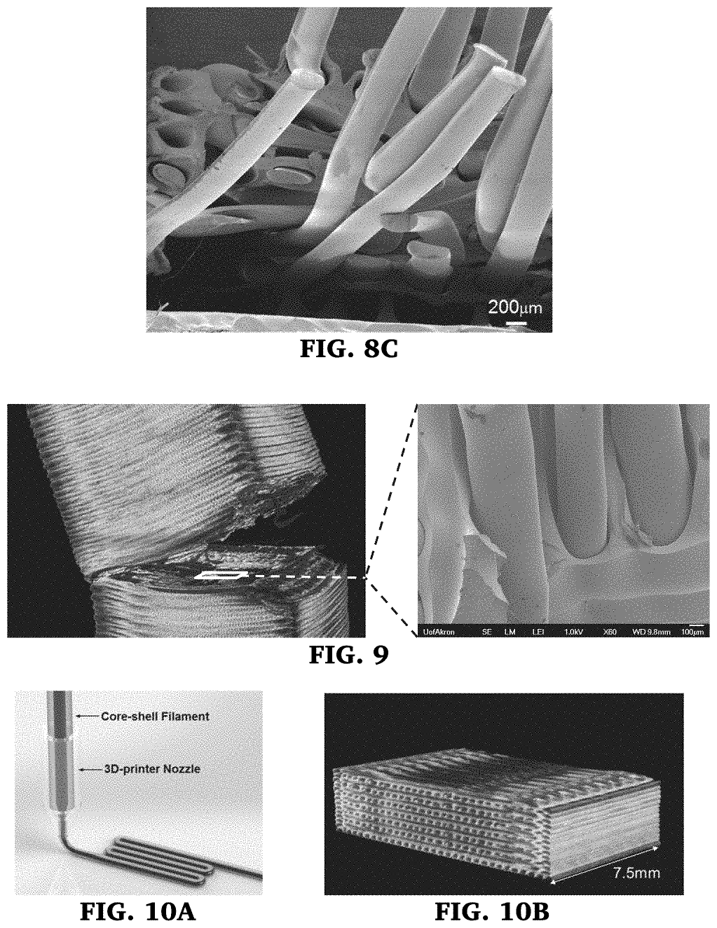

In order to understand the differences in tensile properties, the fracture surfaces were examined. FIG. 8A illustrates voids at the fracture surface of PC samples, which indicates incomplete infill of polycarbonate samples. These voids provide defects in the tensile specimen that can promote failure. Additionally, the resolution of the cross-section of individual filaments is an indication of weak interfaces between the printed filaments, which provide pathways for catastrophic failure. The combination of voids and poor filament interfaces leads to brittle failure for the 3D-printed PC, which is counter to the ductile behavior for PC processed by injection or compression molding. The limited void concentration in the 3D printed Suryln, which leads to smooth fracture surfaces (FIG. 8B). The combination of excellent infill of the object and a well diffused interface leads to tensile behavior similar to the reported bulk properties for the Surlyn. The failure surface of the parts from the core-shell filaments appear to be consistent with fiber reinforced composites, where the PC fibers are elongated and delaminated from the Surlyn matrix at the fracture surface (FIG. 8C). This indicates ductile tensile behavior and provides insights into why the PC filament-reinforced Surlyn based core-shell samples exhibit stress-strain curves similar to expectations for traditionally manufactured PC. This behavior suggests that filling of the voids in the 3D printed par and high strength interfaces between the printed layers are most critical to achieving excellent mechanical properties from FFF parts.

### CONCLUSION

A novel approach to overcome the poor mechanical properties associated with 3D printed parts is demonstrated based on the use of structured filaments. A simple core-shell filament used in 3D printing via FFF is shown to enable synergistic impact performance enhancement through generation of new pathways for energy dissipation and composite-like reinforcement. The printing orientation and composition of the core-shell filament are both important factors in determining the available mechanisms for energy dissipation in 3D-printed PC@Surlyn objects. Individually, printing with either PC or Surlyn leads to high susceptibility to crack propagation, which leads to catastrophic failure on impact. Use of the core-shell filament provides reinforcement from the continuous PC phase along the direction of fiber, thus the impacted specimen does not break when printed in XY and XZ orientation. Delamination of Surlyn from the PC and stretching of PC fibers dissipate the energy from the impact loading, which can provide unprecedented impact resistance for 3D printed polymer parts exceeding 800 J/m. The tensile performance of the PC@Surlyn objects is similar to expectations for traditionally processed (compression or injection molded) PC, although the Young's modulus is decreased due to the lower modulus of the Surlyn matrix. The increased robustness of 3D printed parts will enable the use of core-shell filaments for high-performance applications where the brittle and failure prone nature of standard 3D printed parts are unacceptable.

In light of the foregoing, it should be appreciated that the present invention significantly advances the art by providing a structured filament that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A structured filament for use in fused filament fabrication comprising
an inner core comprising an first polymer or polymer blend; and
an outer shell surrounding said inner core comprising a second polymer or polymer blend;
wherein said first polymer or polymer blend has a higher solidification temperature than said second polymer or polymer blend.

2. The structured filament of claim 1 wherein said first polymer or polymer blend is amorphous.

3. The structured filament of claim 1 wherein said first polymer or polymer blend comprises a polycarbonate, polyphenol-A based polycarbonate, MAKROLON™ 3208 (Covestro, Inc., Pittsburgh, Pa.), polypropylene, nylon, poly(p-phenylene oxide) (PPO), a polycarbonate/acrylonitrile butadiene styrene (ABS) blend, BAYBLEND™ T45 PG (Covestro, Inc., Pittsburgh, Pa.) or a combination thereof.

4. The structured filament of claim 1 wherein said first polymer or polymer blend has a glass transition temperature (T_{g}) of from about 90° C. to about 300° C.

5. The structured filament of claim 1 wherein said second polymer or polymer blend has a T_{g} of from about 40° C. to about 150° C.

6. The structured filament of claim 1 wherein said second polymer or polymer blend has a crystallization temperature (T_{c}) of from about 40° C. to about 150° C.

7. The structured filament of claim 1 wherein said second polymer or polymer blend comprises at least one of crystalline segments and ionizable segments.

8. The structured filament of claim 1 wherein said second polymer or polymer blend comprises from about 0 mol % to about 10 mol % ionizable segments.

9. The structured filament of claim 7 wherein said second polymer or polymer blend comprises one or more crystalline segments.

10. The structured filament of claim 7 wherein said second polymer or polymer blend is partially crystalline after printing.

11. The structured filament of claim 1 wherein said second polymer or polymer blend is selected from an olefin ionomer, zinc neutralized poly(ethylene-co-methacrylic acid), SURLYN™ 9910 (DuPont de Nemours, Inc., Wilmington, Del.), NUCREL™ (Dow, Midland Mich.), ELTEX™ (Ineos, London, UK), PRIMACORE™ (SK Global Chemicals, Seoul, Korea), high density polyethylene, SUNTEC™ B161 (Asahi Kasei, Japan), ADSYL™ 5C37F (LyondellBasell Chemicals Company, Rotterdam, Netherlands), and a combination thereof.

12. The structured filament of claim 1 wherein the energy required to separate said inner core from said outer shell is less than the energy required to propagate a crack through said outer shell.

13. The structured filament of claim 1 wherein the first polymer or polymer blend has a solidification temperature that is from about 5° C. to about 260° C. higher than the solidification temperature of said second polymer or polymer blend.

14. The structured filament of claim 1 wherein the solidification temperature of said first polymer or polymer is at least 5° C. higher than the solidification temperature of said second polymer or polymer blend.

15. The structured filament of claim 1 wherein said inner core comprises from about 35 vol % to about 75 vol % of the structured filament.

16. The structured filament of claim 1 wherein the adhesion between the inner core and outer shell is less than a weld strength between the outer shells of two adjacent 3D printed structured filaments.

17. A 3D printed structure formed by fused filament fabrication of the structured filament of claim 1.

18. The 3D printed structure of claim 17 wherein:
the structured filaments of claim 1 forming said 3D structure are comprised of from about 45% to about 60% of said second polymer or polymer blend, said second polymer or polymer blend forming the outer shell of said structured filaments;
the structured filaments of claim 1 are welded together at their outer shells to form the 3D printed structure, the welds between the outer shells of two adjacent structured filaments in said 3D printed structure having a weld strength;
the inner core and outer shell of said structured filament of claim 1 are joined together with an adhesive force; and
the adhesive force between said inner core and outer shell is less than a weld strength between the outer shells of two adjacent structured filaments in said 3D printed structure.

19. The 3D printed structure of claim 18 wherein said 3D printed structure resists warping.

20. The 3D printed structure of claim 18 having improved dimensional accuracy compared to 3D printed structures formed from comparable filaments made from either one of said first polymer or polymer blend or said second polymer or polymer blend.

21. The 3D printed structure of claim 18 having increased impact resistance compared to 3D printed structures formed from comparable filaments made from either one of said first polymer or polymer blend or said second polymer or polymer blend.

22. The 3D printed structure of claim 17 having an impact resistance of 800 J/m or more in an XY (flat) or XZ (edge-on) printing orientation.
